(19) United States
(12) Patent Application Publication
(10) Pub. No.: US 2016/0218799 A1
(43) Pub. Date: Jul. 28, 2016

(54) OPTICAL MODULATION CONTROL APPARATUS, TRANSMITTER, AND OPTICAL OUTPUT WAVEFORM CONTROL METHOD

(71) Applicant: FUJITSU OPTICAL COMPONENTS LIMITED, Kawasaki-shi (JP)

(72) Inventor: Tomohisa ISHIKAWA, Yokohama (JP)

(73) Assignee: FUJITSU OPTICAL COMPONENTS LIMITED, Kawasaki-shi (JP)

(21) Appl. No.: 14/255,239

(22) Filed: Apr. 17, 2014

(30) Foreign Application Priority Data
May 8, 2013 (JP) 2013-098875

(51) Int. Cl. H04B 10/079; H04B 10/572; H04B 10/54

(52) U.S. Cl. CPC H04B 10/0793; H04B 10/541; H04B 10/572

(57) ABSTRACT

An optical modulation control apparatus includes an optical modulator that includes a pair of parallel optical waveguides and electrodes disposed parallel to the optical waveguides; a waveform monitoring unit that executes a predetermined waveform adjustment with respect to a waveform of an optical signal that is output after modulation by the optical modulator, and produces a monitor signal for modulation control; and a processor that executes the modulation control of the optical modulator, based on adjustment information concerning a desired waveform and the monitor signal output by the waveform monitoring unit such that the waveform of the optical signal that is output after the modulation by the optical modulator becomes a waveform adapted to the adjustment information.

### CROSS REFERENCE TO RELATED APPLICATIONS

This application is based upon and claims the benefit of priority of the prior Japanese Patent Application No. 2013-098875, filed on May 8, 2013, the entire contents of which are incorporated herein by reference.

### FIELD

The embodiments discussed herein are related to an optical modulation control apparatus, a transmitter, and an optical output waveform control method that control an optical modulator.

### BACKGROUND

Wavelength division multiplexing (WDM) communication schemes enable communication of large volumes to be performed over long-distances. In a wavelength division multiplexing communication scheme, an optical module is used that has a wavelength switching function and that executes optical modulation using an external modulator. The optical module is disposed in a transmitting apparatus.

Conventionally, an LN modulator is used as an external modulator for the optical module having the wavelength switching function. High-density integration of lines has also recently been advanced for system apparatuses, and downsizing of the optical module used therein is demanded. Therefore, a semiconductor Mach-Zehnder external modulator, which is more advantageous than the LN modulator in terms of downsizing, tends to be used as an external modulating unit.

However, the transmission property and variation of the refractive index of the semiconductor Mach-Zehnder external modulator are highly dependent on wavelength. Therefore, when the semiconductor Mach-Zehnder external modulator is used for an optical module having a wavelength switching function, a bias voltage and a modulation amplitude voltage have to be set that are matched with the switched wavelength.

For example, a technique is present of acquiring a predetermined extinction ratio by setting and maintaining the operating point of the modulator at a point other than a center point of the optical intensity (see, e.g., Japanese Laid-Open Patent Publication No. 2001-159749) and another technique is present of controlling the extinction ratio and the duty ratio by controlling the position of the cross point of the optical output waveform (see, e.g., Japanese Laid-Open Patent Publication No. 2004-221804).

However, for a modulator, conventionally, the optimal setting value is determined for each wavelength based on a preparatory adjustment and the control is executed using this setting value. For example, the setting value for each wavelength is recorded in memory such as random access memory (ROM); the setting value is read when the wavelength is switched; a bias voltage and a modulation amplitude voltage based on the setting value are applied; and thereby, the semiconductor Mach-Zehnder modulator is operated to execute modulation. Thus, preparatory adjustment work sessions are necessary corresponding to the number of wavelengths and therefore, a significant amount of labor is necessary and the required memory capacity is large.

In addition, when an optical signal is coped with for each transmission condition thereof, the setting value for each transmission condition also needs to be acquired and therefore, greater memory capacity is necessary. For example, to compensate a degradation of the waveform during long-distance transmission, the modulator may apply a predetermined pre-chirp to the optical output and may vary the amount of pre-chirp to match the amount of pre-chirp with the transmission condition of the optical transmission path.

The “degradation of the waveform” refers to broadening of the waveform caused by wavelength dispersion in a fiber consequent to fluctuation of the optical wavelength (or the optical frequency) associated with optical intensity modulation. The “pre-chirp” means intentionally applying, in advance, optical phase modulation (or optical frequency modulation) to the optical waveform to be transmitted to suppress the broadening of the waveform. Adjustment of the amount of pre-chirp causes the amount of optical phase modulation (or the amount of optical frequency modulation) to vary, whereby the broadening of the waveform can be suppressed.

The semiconductor Mach-Zehnder external modulator has a property for the amount of pre-chirp to vary depending on the bias voltage or the modulation amplitude voltage applied to the electrodes, or a combination thereof. Therefore, a setting optimized for each transmission condition is necessary. However, a correlation is present according to which the extinction ratio is degraded when the amount of pre-chirp is simply increased. Therefore, when the amount of pre-chirp is varied, the extinction ratio needs to be controlled corresponding to the variation. Therefore, a significant amount of labor is necessary to acquire and set optimal values for the amount of pre-chirp and the extinction ratio.

As described, a long working time is necessary for the preparatory adjustment to control the modulation operation of the semiconductor Mach-Zehnder external modulator and therefore, productivity cannot be improved. The cost of the modulator and the transmitter thereof increase as well.

### SUMMARY

According to an aspect of an embodiment, an optical modulation control apparatus includes an optical modulator that includes a pair of parallel optical waveguides and electrodes disposed parallel to the optical waveguides; a waveform monitoring unit that executes a predetermined waveform adjustment with respect to a waveform of an optical signal that is output after modulation by the optical modulator, and produces a monitor signal for modulation control; and a processor that executes the modulation control of the optical modulator, based on adjustment information concerning a desired waveform and the monitor signal output by the waveform monitoring unit such that the waveform of the optical signal that is output after the modulation by the optical modulator becomes a waveform adapted to the adjustment information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an optical modulation control apparatus according to an embodiment;

FIG. 2 is a diagram of an overall configuration for wavelength division multiplexing communication, including the optical modulation control apparatus;

FIG. 3 is a block diagram of an example of an internal configuration of the optical modulation control apparatus according to a first embodiment;

FIG. 4 is a flowchart of a phase difference correction process;

FIG. 5 is an explanatory chart of the variation of optical intensity for phase adjustment;

FIG. 6 is a flowchart of a control process to stabilize the extinction ratio according to the first embodiment;

FIGS. 7A and 7B are diagrams of examples of the waveforms output by a modulating unit and the output of a peak level stabilizing unit;

FIGS. 8A and 8B are diagrams of examples of output waveforms of a differential output unit;

FIG. 9 is a block diagram of an example of an internal configuration of the optical modulation control apparatus according to a second embodiment;

FIG. 10 is a flowchart of a control process to stabilize the duty ratio, according to the second embodiment;

FIGS. 11A, 11B, 12A and 12B are diagrams of examples of output waveforms for different duty ratios;

FIG. 13 is a block diagram of an example of an internal configuration of the optical modulation control apparatus according to a third embodiment;

FIG. 14 is a block diagram of an example of an internal configuration of the optical modulation control apparatus according to a fourth embodiment;

FIG. 15 is a diagram depicting a waveform in a case where the pre-chirp amount is varied;

FIG. 16 is a diagram depicting a waveform in a case where the pre-chirp amount is varied; and

FIG. 17 is a flowchart of control processes to stabilize the extinction and the duty ratios, and to vary the pre-chirp according to the fourth embodiment.

### DESCRIPTION OF EMBODIMENTS

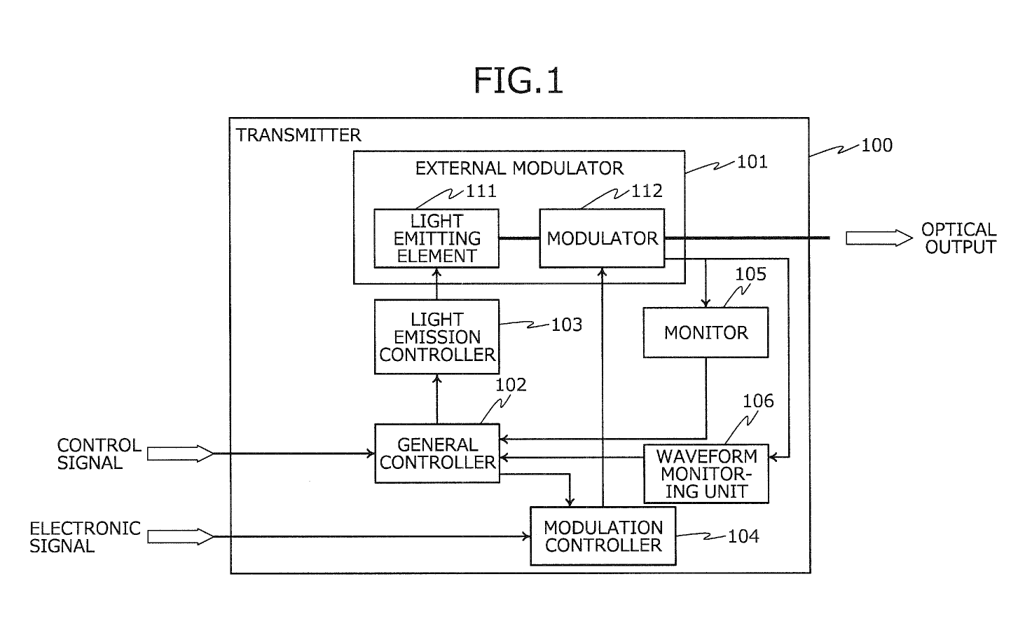

Embodiments will be described in detail with reference to the accompanying drawings. FIG. 1 is a block diagram of an optical modulation control apparatus according to an embodiment, and depicts a transmitter 100 of an optical module that includes the optical modulation control apparatus. The transmitter 100 includes an external modulator 101, a general controller 102, a light emission controller 103, a modulation controller 104, a monitor 105, and a waveform monitoring unit 106.

The external modulator 101 includes a light emitting element (a light source) 111 such as an LD, and a modulator 112 such as a semiconductor Mach-Zehnder modulator. The light emitting element 111 outputs to the modulator 112, an optical signal of a direct current optical output; and the modulator 112 optically modulates the optical signal.

The general controller 102 receives an input of adjustment information such as adjustment items for the waveform, and a detection signal (monitor signal) of an optical output; and supervises and controls the light emission controller 103 and the modulation controller 104. Although described later, for the general controller 102, a processor such as a central processing unit (CPU) executes the control using memory such as ROM or random access memory (RAM). The light emission controller 103 controls the light emission of the light emitting element 111 using a wavelength set therefor, etc. The modulation controller 104 receives in input of data (an electronic signal) that is to be transmitted optically, controls the modulation by the modulator 112, and executes control to optically output the data.

The Mach-Zehnder modulator 112 includes optical output ports of two systems. The optical output of one system is output to an external optical fiber, etc. The optical output of the other system is monitored (detected) to control the external modulator 101 in the transmitter 100; and is optically detected by the monitor 105 and the waveform monitoring unit 106, respectively.

The monitor 105 detects the wavelength and the power of the optical output to be transmitted. The waveform monitoring unit 106 detects the waveform of the optical output to be transmitted. The detection signals of the wavelength, the power, and the waveform of the optical output detected by the monitor 105 and the waveform monitoring unit 106 are output to the general controller 102.

The general controller 102 controls based on the detection signals of the monitor 105, the wavelength and the power of the optical output to be transmitted; and controls based on the detection signal of the waveform monitoring unit 106, the extinction ratio of the optical output to be transmitted.

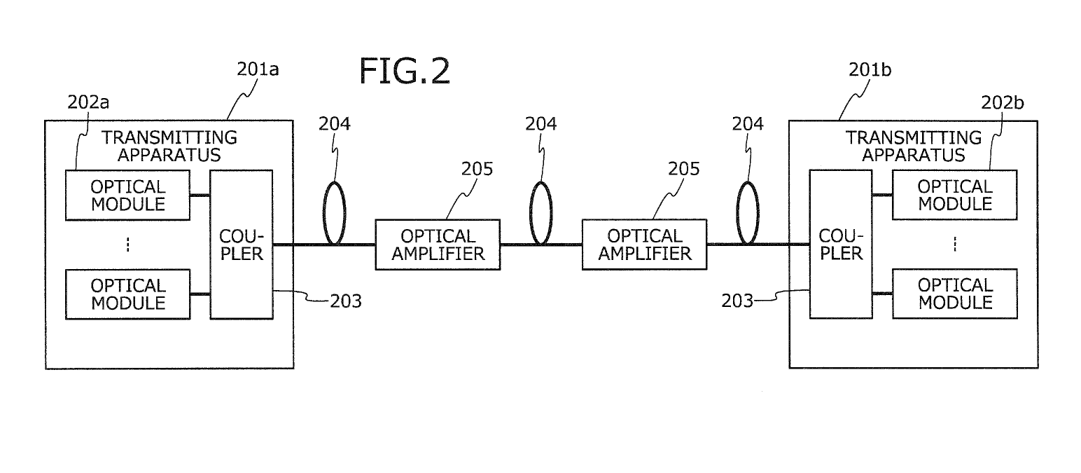

FIG. 2 is a diagram of an overall configuration for wavelength division multiplexing communication, including the optical modulation control apparatus. A pair of transmitting apparatuses 201a and 201b are connected to each other for communication through an optical transmission path 204 such as an optical fiber. The transmitting apparatuses 201a and 201b respectively include plural optical modules 202a and 202b. For example, assuming that the transmitting apparatuses 201a and 201b respectively act for transmission and reception, the transmitter (the transmitter) 100 depicted in FIG. 1 is disposed in each of the optical modules 202a of the transmitting apparatus 201a.

The plural optical modules 202a of the transmitting apparatus 201a are connected to a coupler 203. The coupler 203 couples and outputs to the optical transmission path 204, the optical signals output by the transmitters 100 of the optical modules 202a. In the transmitting apparatus 201b, the coupler 203 branches and outputs to the plural optical modules 202b, the optical signal transmitted by the optical transmission path 204.

In the wavelength division multiplexing (WDM) communication, the plural transmitters 100 of the transmitting apparatus 201a on the transmission side, optically output optical signals each having a wavelength differing; and the coupler 203 couples the optical signals and optically outputs the coupled optical signals to the optical transmission path 204. In the other transmitting apparatus 201b (for reception), the coupler 203 branches and outputs the transmitted optical signal having the different wavelengths; and the plural receivers receive the optical signals of the respective wavelengths. As depicted in FIG. 2, in the long-distance optical transmission path 204, plural optical amplifiers 205 are disposed at predetermined-intervals to optically amplify the transmitted optical signal.

Without limitation to the configuration (for one-way communication) depicted in FIG. 1, a configuration may be employed for the optical modules 202a and 202b, in which each includes the transmitter 100 and the receiver. In this case, two optical transmission paths 204 are used to be divided into those for the uplink system and the downlink system to transmit optical signals. Thereby, the transmitting apparatuses 201a and 201b can each execute two-way communication.

The waveform monitoring unit 106 monitors the waveform of the modulated output of the modulator 112, and outputs a monitor signal to the general controller 102. The general controller 102 controls the extinction ratio based on the monitor signal. In a first control example, the waveform monitoring unit 106 produces a monitor signal that is suitable for the control of the extinction ratio and that controls the extinction ratio of the optical output (the waveform of the optical output) to be constant. As for the monitor signal: the peak level of the signal component of the optical signal of the modulator 112 is caused to be constant and is amplified; a difference is acquired by comparing the average value level of the output (the non-inverter output) of a non-inverter signal differentially output with the average value level of the output (the inverter output) of a inverter signal differentially output; the general controller 102 controls the modulation amplitude voltage for the modulator 112 such that the acquired difference maintains a specific state thereof; and thereby, the extinction ratio of the optical output (the waveform of the optical output) is controlled to be constant (first embodiment).

The waveform monitoring unit 106 monitors the waveform of the modulation output of the modulator 112, and outputs a monitor signal to the general controller 102. The general controller 102 controls the duty ratio based on the monitor signal. In a second control example, the waveform monitoring unit 106 produces a monitor signal that is suitable for the control of the duty ratio and that controls the duty ratio to be constant. As for the monitor signal: a modulated component is extracted from the differential output; a difference is acquired by comparing the smoothed voltage of the non-inverter output with the smoothed voltage of the inverter output; the general controller 102 controls the duty of the modulated signal for the modulator 112 such that the acquired difference maintains a specific state; and thereby, the duty ratio of the waveform of the optical output is controlled to be constant (second embodiment).

The waveform monitoring unit 106 and the general controller 102 may include both configurations of the first and the second control examples. The input signal for the modulator 112 is adjusted using any one of the controls including the first and the second control examples or a combination thereof, and thereby, the extinction and the duty ratios of the optical output are controlled to be constant (third embodiment).

In addition to the third control example, in a fourth control example, the waveform monitoring unit 106 monitors the waveform of the modulation output of the modulator 112, detects the pre-chirp, and outputs the detected amount of the pre-chirp to the general controller 102. The automatic formation of the waveform and the stabilization control by the general controller 102 are interlocked with each other and thereby, control is executed to acquire the necessary amount of pre-chirp, maintaining the waveform (fourth embodiment).

The general controller 102 facilitates the automatic shaping and the stabilization of the waveform of the modulator 112, independent of the setting of the wavelength of the optical output of the light emitting element 111 and for any wavelength and any optical power, by executing the above control each time the wavelength is switched. Because of the non-dependence on the setting of the wavelength of the optical output, highly precise control can be executed using a simple configuration and any increase of the setting amount for the memory disposed in the general controller 102 can be prevented. The memory (for example, the ROM) merely has to store the information concerning the light emission control (light emission wavelength and the optical power) of the light emission controller 103, and the information concerning the modulation control of the modulation controller 104 does not need to be stored thereby. The control for the extinction and the duty ratios to be constant is executed corresponding to the adjustment items of the waveform indicated by the adjustment information set in the general controller 102. For example, a user (a manager), etc. sets a desired predetermined extinction ratio and a desired predetermined duty ratio as the adjustment items and inputs these items into the general controller 102.

Examples of configurations of the first to the fourth embodiments corresponding to the first to the fourth control examples will be described in detail.

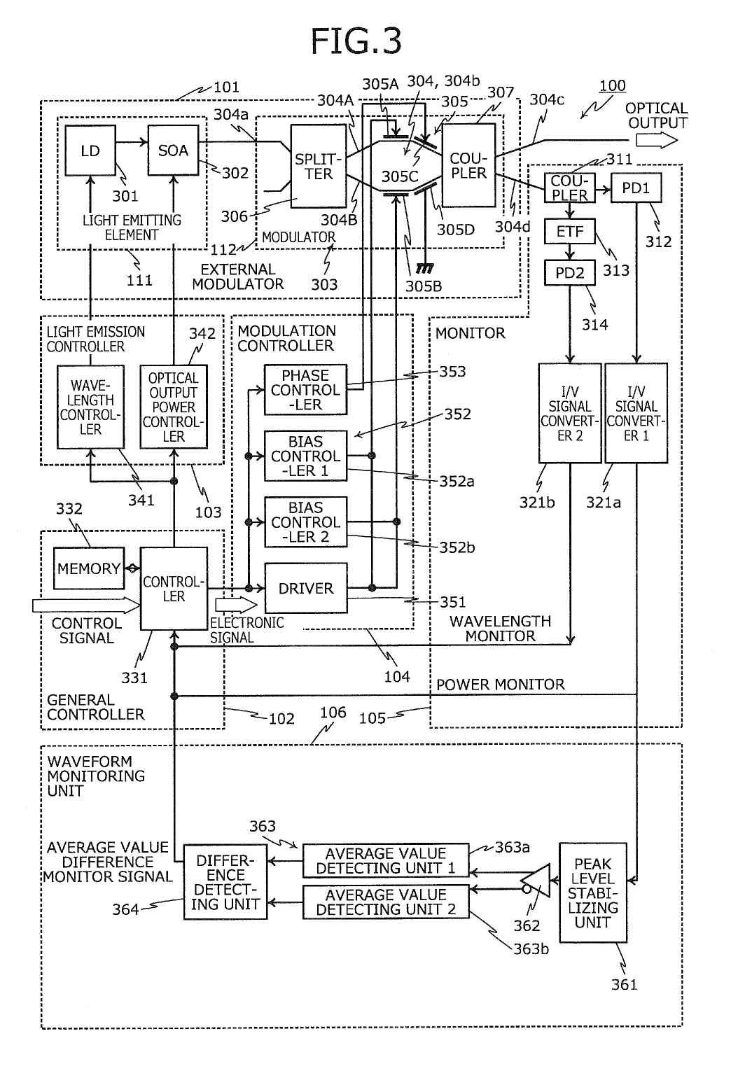

FIG. 3 is a block diagram of an example of an internal configuration of the optical modulation control apparatus according to the first embodiment. In the first embodiment, an example of a configuration to control the extinction ratio to be constant will be described. The configuration of the transmitter 100 including the optical modulation control apparatus depicted in FIG. 1 will be described in detail with reference to FIG. 3.

The light emitting element 111 of the external modulator 101 includes an LD 301 as a light source, and a semiconductor optical amplifier (SOA) 302 that optically amplifies the output light beam of the LD 301.

The modulator 112 is a semiconductor Mach-Zehnder modulator and includes a pair of optical waveguides 304 (a first arm 304A and a second arm 304B) that are formed on a substrate 303 having an electro-optical effect, and signal electrodes 305 formed along the optical waveguides 304. Among the optical waveguides 304, an input port 304a of an input-side waveguide receives an input of an optical signal having a predetermined wavelength from the light emitting element 111, and a splitter 306 branches the optical signal into branches for a pair of optical waveguides 304 (parallel waveguides 304b).

In the parallel waveguides 304b, the optical signals are modulated by the signal electrodes 305 and thereafter, are coupled by a coupler 307. The signal electrodes 305 include a first electrode 305A and a second electrode 305B respectively disposed on the side of the first arm 304A and on the side of the second arm 304B; and also include a first phase adjuster 305C and a second phase adjuster 305D (electrodes) respectively disposed on the side of the first arm 304A and the side of the second arm 304B.

The optical signal, after being coupled by the coupler 307, is optically output from an output port 304c of an output waveguide on the output side, to an external destination. The other output port 304d is monitored (detected) to control the external modulator 101 in the transmitter 100.

The other output port 304d outputs signals to the monitor 105. The monitor 105 includes a coupler 311, an optical element 313, light receiving elements (PDs) 312 and 314, and a signal converter 321. Among these components, the coupler 311, the optical element 313, and the light receiving elements (PDs) 312 and 314 are disposed on the substrate 303 of the modulator 112.

The coupler 311 branches into two, the optical signal optically output from the other output port 304d of the optical waveguides 304 of the modulator 112. The light receiving element (PD1) 312 detects the optical power (optical intensity) of one of the optical signal branches. The light receiving element (PD2) 314 detects the optical power of the other optical signal branch corresponding to the wavelength through the optical element (for example, an etalon filter (ETF)) having a transmission property with a cyclic nature for the wavelength.

The signal converter 321 converts a current output from the light receiving element (PD) into a voltage (I/V conversion), and includes signal converters (I/V converters 1 and 2) 321a and 321b respectively for the light receiving elements (PD1 and PD2) 312 and 314. Output from the I/V converter 1 (321a) is output to the general controller 102 as a power monitor signal for the optical power detection. Output from the I/V converter 2 (321b) is output to the general controller 102 as a wavelength monitor signal for the wavelength detection.

The general controller 102 includes a controller 331 such as a CPU, and memory 332 such as ROM or RAM. The controller 331 executes a control process to supervise the transmission of the transmitter 100, by execution of a program on a processor such as a CPU. The memory 332 stores information concerning the light emission control for the light emitting element 111. The “information concerning the light emission control” is information concerning the light emission wavelength and the optical power (the optical intensity) of the light emitting element 111.

The controller 331 reads the information (the light emission wavelength and the optical power) concerning the light emission control and stored in the memory 332 for each wavelength to be switched to, and thereby, controls the emission of light by the light emitting element 111.

The controller 331 controls the modulation of the modulator 112, without using any information in the memory 332. The controller 331 receives, as a control signal, an input of data to be optically transmitted. The data is output to the modulator 112 through the modulation controller 104.

The controller 331, based on the difference signal output by the waveform monitoring unit 106, controls a driver 351 such that the extinction ratio of the optical output is constant; and in addition, executes control based on the difference signal output by the waveform monitoring unit 106, such that the duty ratio of the optical output is a desired constant duty ratio.

The light emission controller 103 includes a wavelength controller 341 and an optical output power controller 342. The wavelength controller 341 controls the light emission wavelength of the LD 301 of the light emitting element 111, based on the wavelength control of the controller 331 of the general controller 102. The optical output power controller 342 controls the optical amplification rate (gain) of the SOA 302 of the light emitting element 111, based on the control of the controller 331 of the general controller 102.

The modulation controller 104 includes the driver 351, a bias controller 352, and a phase controller 353. The driver 351 controls and drives the modulator 112, based on the electronic signal for transmission output by the controller 331 of the general controller 102; and outputs a predetermined driving signal to the first and the second electrodes 305A and 305B respectively disposed on the sides of the first and the second arms 304A and 304B and by modulation, superimposes on the optical signal to be transmitted in the optical waveguides 304 (the parallel waveguides 304b), the data (the electronic signal) that is to be transmitted.

The bias controller 352 includes bias controllers 1 and 2 (352a and 352b), and executes bias control of the modulator 112 through the signal electrodes 305, based on the bias control of the controller 331 of the general controller 102. The bias controllers 1 and 2 (352a and 352b) respectively control bias and driving, by applying a predetermined bias voltage to the first and the second electrodes 305A and 305B respectively disposed on the sides of the first and the second arms 304A and 304B.

The phase controller 353 controls the phase modulation of the modulator 112, through the signal electrode 305 and based on the phase control of the controller 331 of the general controller 102; and outputs a driving signal for the phase control to the first phase adjuster (the electrode) 305C disposed on the side of the second arm 304A. The second phase adjuster (the electrode) 305D is grounded.

The waveform monitoring unit 106 includes a peak level stabilizing unit 361, a differential output unit 362, an average value detecting unit 363, and a difference detecting unit 364.

The peak level stabilizing unit 361 receives an input of the output (the optical power) from the I/V converter 321a of the monitor 105, and maintains the peak level at a determined constant level (a reference peak level) regardless of the magnitude of the amplitude (the difference in the level between the peak level and the bottom level) of the detected optical signal.

The differential output unit 362 outputs a non-inverter output formed by setting the peak level of the amplitude of the optical signal to be the predetermined reference peak level and a inverter output formed by setting the bottom level of the amplitude of the optical signal to be a predetermined reference bottom level, based on the output of the peak level stabilizing unit 361.

The average value detecting unit 363 includes average value detecting units 1 and 2 (363a and 363b). The average value detecting units 1 and 2 (363a and 363b) respectively detect average values (the difference in the level between the peak level and the bottom level) of the amplitudes of the optical signals at the non-inverter and the inverter outputs of the differential output unit 362.

The difference detecting unit 364 detects the difference between the average values detected by the average value detecting units 1 and 2 (363a and 363b). An average value difference monitor signal indicating the difference between the average values detected by the difference detecting unit 364 is output to the controller 331 of the general controller 102 and is used for the control to stabilize the extinction ratio.

In the first embodiment, the control is executed to stabilize the extinction ratio of the optical output of the external modulator 101. Before the execution of the control to stabilize the extinction ratio, a first phase adjustment voltage is determined and applied to the first phase adjuster (the electrode) 305C, and a process is executed of correcting the difference in the phase between the first and the second arms 304A and 304B (a phase difference correction process). The determination of the first phase adjustment voltage is executed to correct the phase each time the transmitter 100 modulates and outputs an optical signal having a predetermined wavelength and a predetermined optical power, that is, each time the wavelength is switched.

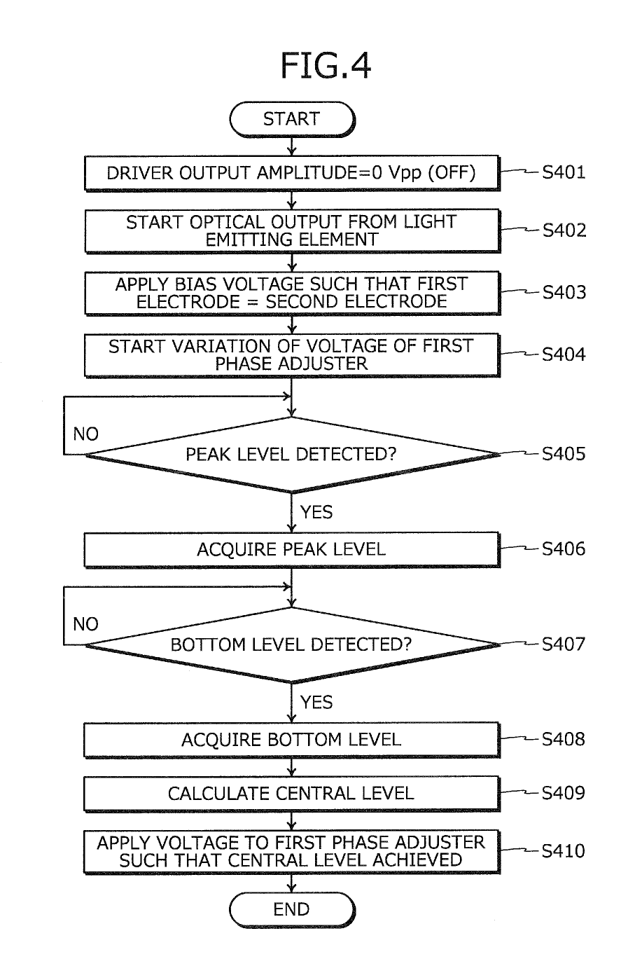

FIG. 4 is a flowchart of the phase difference correction process. The processes executed by the controller 331 of the general controller 102 will be described.

The controller 331 sets an output modulation amplitude of the driver 351 of the modulation controller 104 to be 0 Vpp (OFF) (step S401), and controls the light emission controller 103 to start the optical output from the light emitting element 111 (step S402). At this step, the light emitting element 111 outputs the optical signal having the predetermined wavelength using the LD 301 and the optical signal is output as an optical signal having the predetermined optical output power by the optical amplification executed by the SOA 302.

The controller 331 applies bias voltages of the same potential to the first and the second electrodes 305A and 305B of the modulator 112 through the driver 351 (step S403). At this step, the controller 331 detects the optical output from the modulator 112 through the monitor 105 and adjusts the output wavelength and the output power of the optical output of the light emitting element 111 such that the values of these items become desired values.

The controller 331 fixes the output from the light emitting element and starts variation of the voltage of the first phase adjuster (the electrode) 305C of the modulator 112 (step S404). Thereafter, processes are executed such as a process executed by the monitor 105 of detecting the optical power (the peak level and the bottom level) of the optical signal during the variation of the voltage; and a process executed by the controller 331 of acquiring the voltage of the first phase adjuster (the electrode) 305C to be the central level between the peak level and the bottom level.

Until the I/V converter 321a of the monitor 105 detects the peak level of the optical signal (step S405: NO), the controller 331 varies the voltage of the first phase adjuster (the electrode) 305C of the modulator 112. When the I/V converter 321a detects the peak level of the optical signal (step S405: YES), the controller 331 acquires (retains) the peak level PH at this time (step S406).

Until the I/V converter 321a of the monitor 105 detects the bottom level of the optical signal (step S407: NO), the controller 331 varies the voltage of the first phase adjuster (the electrode) 305C of the modulator 112. When the I/V converter 321a detects the bottom level of the optical signal (step S407: YES), the controller 331 acquires (retains) the bottom level PL at this time (step S408).

Thereafter, the controller 331 calculates the central level of the peak and the bottom levels PH and PL based on the acquired peak and the acquired bottom levels PH and PL (step S409), and applies the voltage of the calculated central level to the first phase adjuster (the electrode) 305C (step S410).

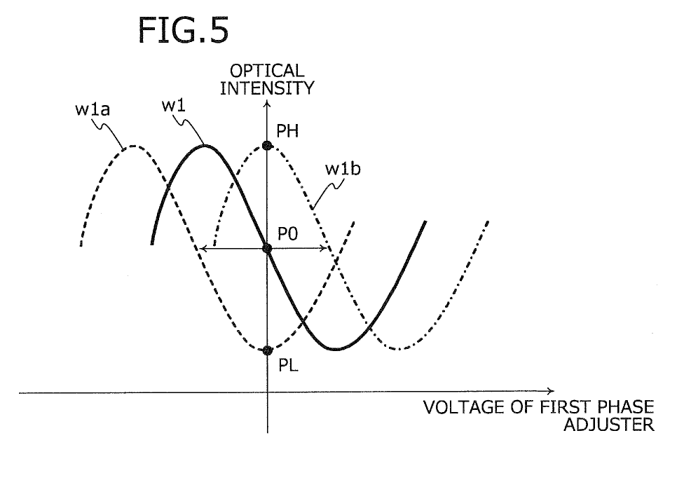

FIG. 5 is an explanatory chart of the variation of the optical intensity for phase adjustment. FIG. 5 depicts the variation of the optical intensity (the axis of ordinate) acquired when the voltage (the axis of abscissa) that is applied to the first phase adjuster (the electrode) 305C of the modulator 112 is varied. The “peak level”, the “bottom level”, and the “central level” of FIG. 4 will be described.

The monitor 105 detects an optical signal w1 having a predetermined phase with a π-curve property by the predetermined voltage applied to the first phase adjuster (the electrode) 305C, to have an optical intensity P0. The variation of the voltage of the first phase adjuster (the electrode) 305C causes the phase of the optical signal to shift as indicated by “w1a” or “w1b”. Corresponding to this, the optical intensity detected by the monitor 105 varies. When the phase varies like “w1a” or “w1b”, the optical intensity respectively becomes “PL” or “PH”.

The variation of the optical intensity is detected (monitored) by the controller 331 through the light receiving element (PD1) 312 and the I/V converter 1 (321a) of the monitor 105. The controller 331 detects the peak and the bottom levels PH and PL from the monitoring result, calculate the central level between the peak and the bottom levels PH and PL, and applies the voltage of the central level to the first phase adjuster (the electrode) 305C.

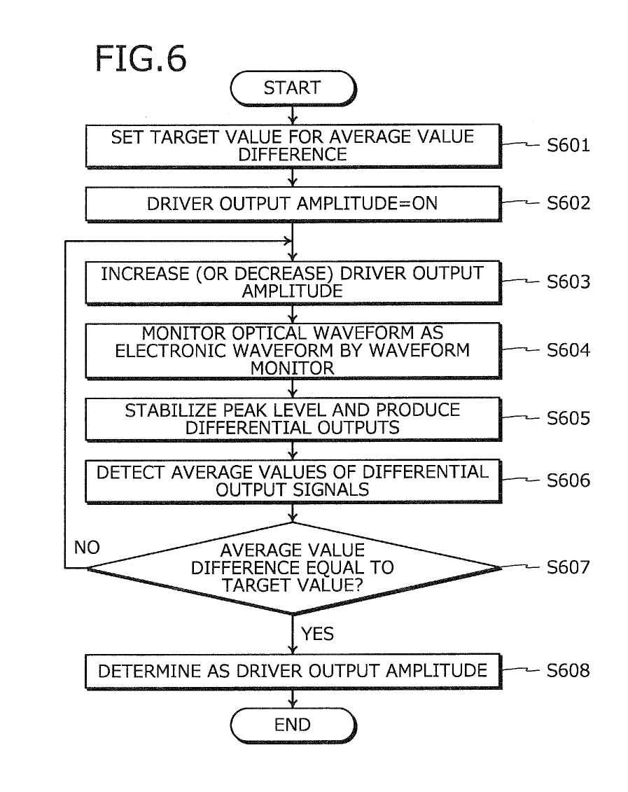

FIG. 6 is a flowchart of the control process of stabilizing the extinction ratio according to the first embodiment. Processes that are executed by the waveform monitoring unit 106, and the controller 331 of the general controller 102 will be described. The process depicted in FIG. 6 is executed after execution of the process of determining the first phase adjustment voltage depicted in FIG. 4.

A target value is set in the controller 331 (step S601). To acquire the predetermined constant extinction ratio, the controller 331 executes control to match the value (the difference) of the average value difference monitor signal output by the difference detecting unit 364 with the target value. The “target value” is set corresponding to the desired extinction ratio.

The controller 331 causes the light emitting element 111 to optically output an optical signal having the predetermined wavelength and the predetermined optical power, and controls the driver 351 of the modulation controller 104 to have the output amplitude On (step S602). Thereby, the modulator 112 optically modulates the direct current optical output from the light emitting element 111.

Thereafter, the controller 331 executes the process of determining the driver output amplitude by causing the average value difference to converge on the target value by varying the output amplitude of the driver 351. For example, the output amplitude of the driver 351 is increased between “small” to “large” (step S603). At this time, the waveform monitoring unit 106 monitors the optical waveform as an electronic waveform through the light receiving element (PD1) 312 and the I/V converter 1 (321a) of the monitor 105 (step S604).

The waveform monitoring unit 106 executes the stabilization of the peak level of the optical signal using the peak level stabilizing unit 361 and production of the differential outputs (the non-inverter output and the inverter output), using the differential output unit 362 (step S605). The average value detecting unit 363 detects the average values of the non-inverter and the inverter outputs (step S606). The difference detecting unit 364 outputs to the controller 331, the difference of the average values of the non-inverter and the inverter outputs, as the average value difference monitor signal.

The controller 331 determines whether the value of the difference of the average value difference monitor signal is equal to the target value set at step S601 (or is converged within a predetermined range) (step S607). If the controller 331 determines that the average value difference is not equal to the target value (step S607: NO), the controller 331 returns to the process at step S603. If the controller 331 determines that the average value difference is equal to the target value (or within the predetermined range) (step S607: YES), the controller 331 determines that the output amplitude of the driver 351 at this time is used (step S608) and causes the process to come to an end.

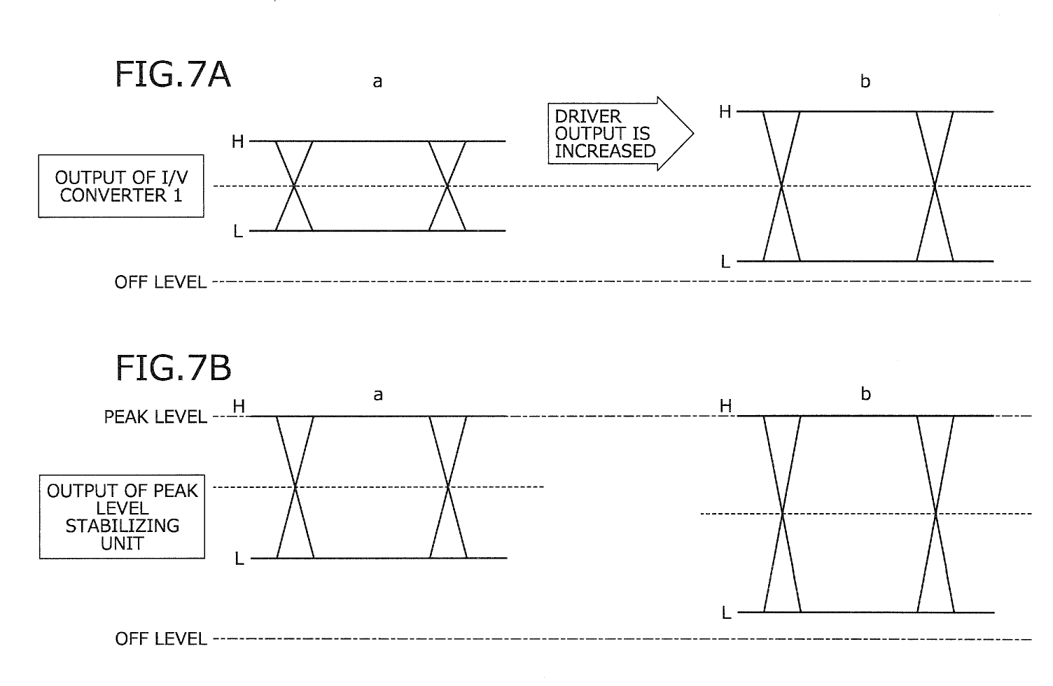

Detailed description will be made using examples of waveforms of the optical signal in the above components. FIGS. 7A and 7B are diagrams of examples of the waveforms output by the modulating unit and the output of the peak level stabilizing unit. FIG. 7A depicts the output waveforms of the I/V converter 1 (321a) of the monitor 105 that monitors the optical signal of the modulator 112. FIG. 7B depicts the output waveforms of the peak level stabilizing unit 361 of the waveform monitoring unit 106. In FIGS. 7A and 7B, a and b respectively depict cases where the output amplitude of the driver 351 is “small” and where the output amplitude thereof is “large”.

With an increase of the output amplitude of the driver 351, with respect to the output of the I/V converter 1 (321a), as depicted in a and b, the average level (the central level) of the optical output stays at the same level while only the amplitude (H/L) increases.

The output of the peak level stabilizing unit 361 is controlled such that the peak level stays at the same level (the H level of the optical signal stays at the same level) even when the output amplitude of the driver 351 varies (increases). When the output amplitude of the driver 351 increases, the amplitude increases toward the “Off” level while the peak level stays constant.

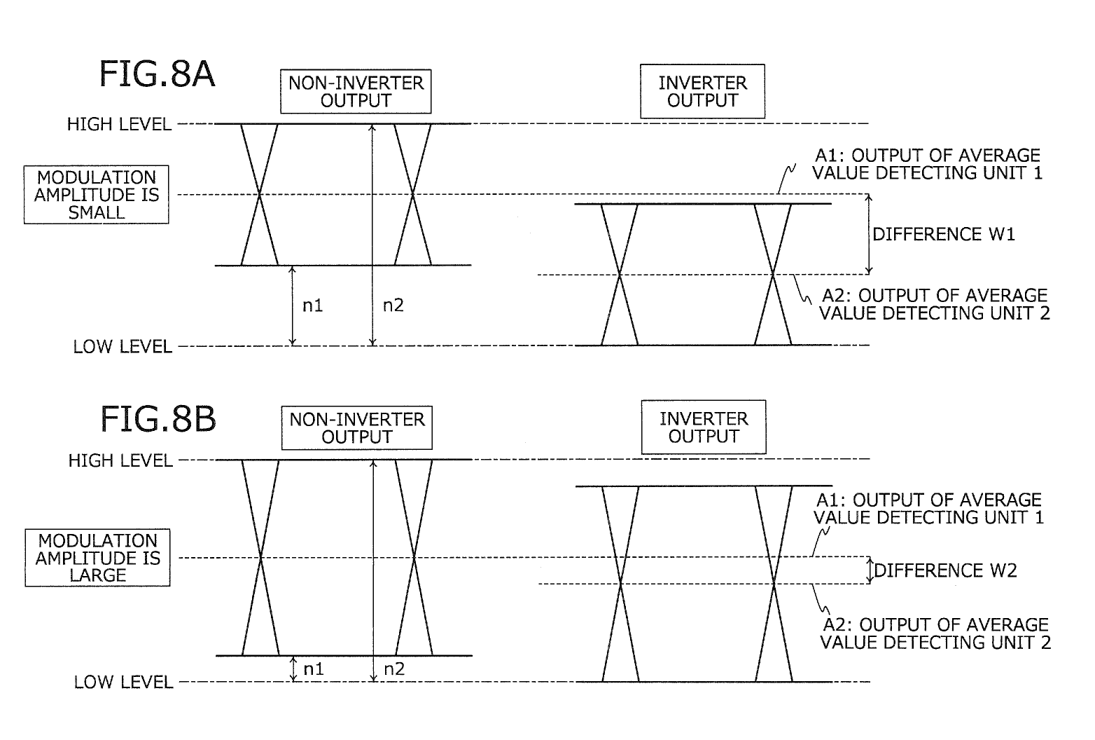

FIGS. 8A and 8B are diagrams of examples of output waveforms of the differential output unit. The right and left portions of FIGS. 8A and 8B respectively depict the non-inverter outputs and the inverter outputs. FIGS. 8A and 8B respectively depict cases where the modulation amplitude of the modulator 112 is “small” and where the modulation amplitude is “large”. The non-inverter output is output whose peak level of the optical signal matches (sticks to) the “H” level and the inverter output is output whose bottom level of the optical signal matches the “L” level.

In FIGS. 8A and 8B, the “L” level and the bottom level of the optical signal have a level difference n1 therebetween, and the peak level of the optical signal (the “H” level) and the “L” level have a level difference n2 therebetween. “n1:n2” represents the extinction ratio.

The average value detecting units 1 and 2 (363a and 363b) respectively output average values A1 and A2 that are the average values of the “H” and the “L” levels for the non-inverter and the inverter outputs.

On the other hand, as depicted in FIG. 8B, when the modulation amplitude is large, the difference detecting unit 364 detects that a difference W2 between the average values A1 and A2 is small.

As depicted in FIG. 8A, when the modulation amplitude is small and the extinction ratio is degraded, the output difference (a difference W1) is significant between the average values A1 and A2 respectively detected by the average value detecting units 1 and 2 (363a and 363b). When the extinction ratio is improved by increasing the modulation amplitude, as depicted in FIG. 8B, the output difference (the difference W2) is reduced between the average value detecting units 1 and 2 (363a and 363b).

The output peak of the differential output unit 362 is maintained to a constant peak level. The difference detecting unit 364 detects the difference W between the average values A1 and A2 and outputs the average value difference monitor signal to the controller 331.

The controller 331 controls the modulation output amplitude of the driver 351 such that the difference W between the average values A1 and A2 becomes a specific difference (a predetermined difference within a range from the difference W1 to the difference W2). Thereby, even when the transmission property of the semiconductor Mach-Zehnder external modulator 101 and the light receiving sensitivity, etc. of each of the light receiving elements (PDs 1 and 2) 312 and 313 are dependent on wavelength, the extinction ratio can be maintained to be constant.

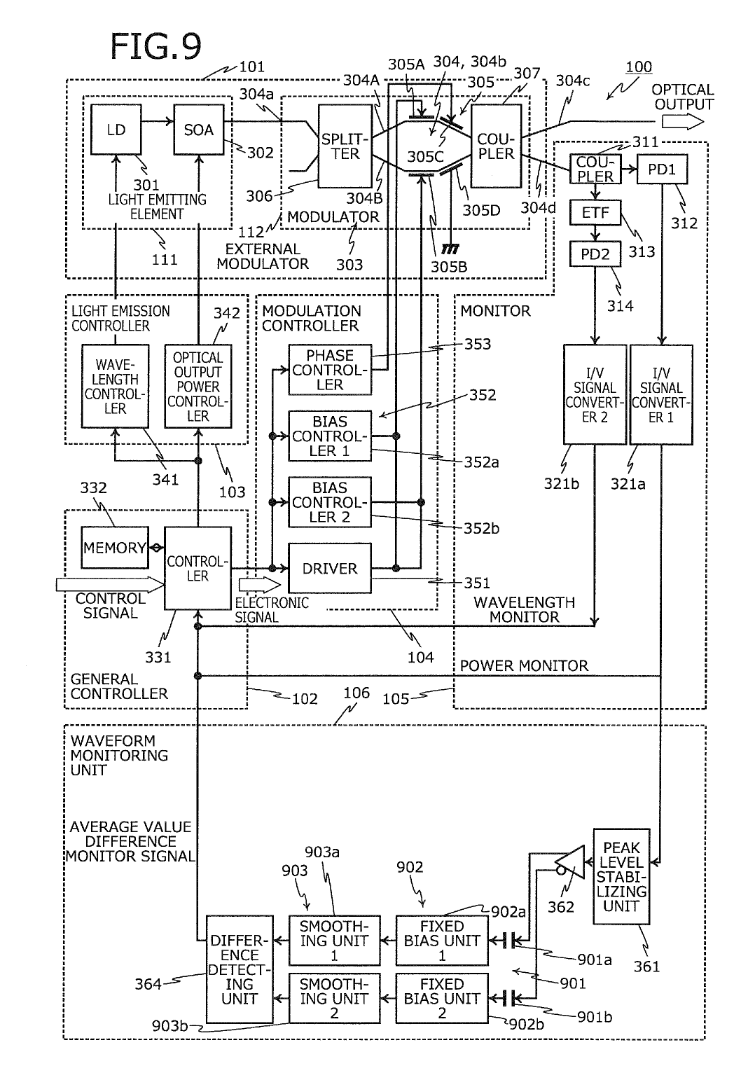

FIG. 9 is a block diagram of an example of an internal configuration of the optical modulation control apparatus according to the second embodiment. In the second embodiment, an example of a configuration to control the duty ratio to be constant will be described. The configuration of the transmitter 100 including the optical modulation control apparatus depicted in FIG. 1 will be described in detail with reference to FIG. 9. In FIG. 9, components different from those of the first embodiment include the waveform monitoring unit 106, while other components are given the same reference numerals used in the first embodiment (FIG. 3) and will not again be described.

The controller 331 executes control to stabilize the duty ratio of the optical output for the driver 351, based on the difference signal output by the waveform monitoring unit 106.

The waveform monitoring unit 106 includes the peak level stabilizing unit 361, the differential output unit 362, an AC coupler 901, a fixed bias element 902, a smoothing unit 903, and the difference detecting unit 364.

The peak level stabilizing unit 361 receives an input of the output (the optical power) of the I/V converter 321a of the monitor 105, and maintains the peak level at a determined constant level (the reference peak level) regardless of the magnitude of the amplitude (the difference in the level between the peak level and the bottom level) of the detected optical signal.

The differential output unit 362 outputs the non-inverter output formed by setting the peak level of the optical signal to be the predetermined reference peak level and the inverter output formed by setting the bottom level of the amplitude of the optical signal to be the predetermined reference bottom level, based on the output of the peak level stabilizing unit 361.

The AC coupler 901 includes AC couplers 1 and 2 (901a and 901b). The AC couplers 1 and 2 (901a and 901b) respectively extract the alternate current signal components of the non-inverter output and the inverter output of the differential output unit 362.

The fixed bias element 902 includes fixed bias elements 1 and 2 (902a and 902b). The fixed bias elements 1 and 2 (902a and 902b) respectively apply a predetermined bias voltage to modulated signals of the non-inverter output and the inverter output.

The smoothing unit 903 includes smoothing units 1 and 2 (903a and 903b). The smoothing unit 1 (903a) includes a smoothing circuit, etc. that smoothes the modulated signal of the non-inverter output. The smoothing unit 2 (903b) smoothes the modulated signal of the inverter output.

The difference detecting unit 364 detects the difference in the output of the smoothing units 1 and 2 (903a and 903b). A smoothed value difference monitor signal indicating the difference detected by the difference detecting unit 364 is output to the controller 331 of the general controller 102 and is used for the duty stabilization control.

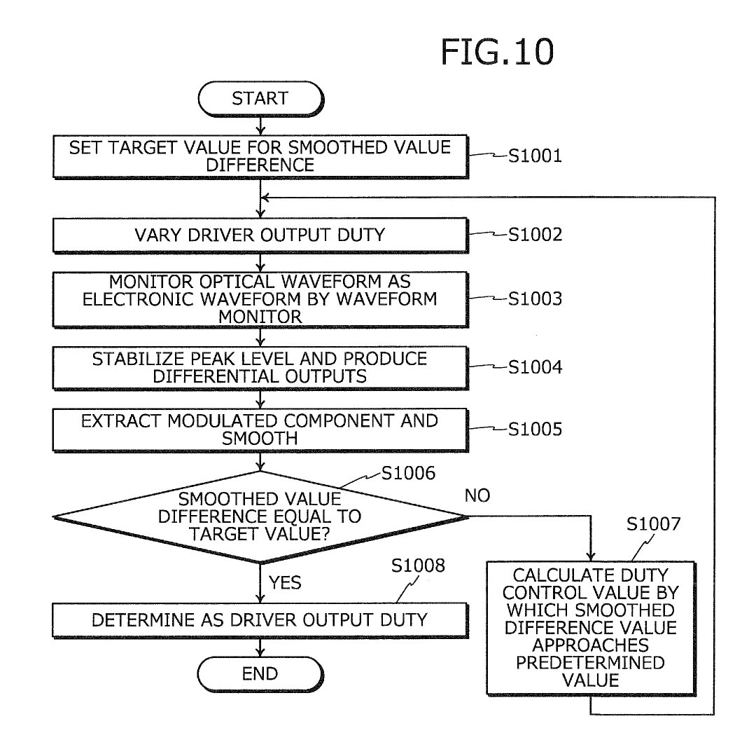

FIG. 10 is a flowchart of the control process to stabilize the duty ratio, according to the second embodiment. Processes will be described that are executed by the waveform monitoring unit 106, and the controller 331 of the general controller 102. The processes of FIG. 10 are executed after the first phase adjustment voltage determination process (the phase difference correction process) described in the first embodiment (FIG. 4).

A target value is set in the controller 331 (step S1001). To acquire a predetermined constant duty ratio, the controller 331 executes control to cause the value of the smoothed value difference monitor signal (the difference) output by the difference detecting unit 364 to match the target value.

The controller 331 causes the light emitting element 111 to optically output an optical signal having the predetermined wavelength and the predetermined optical power, and varies the duty output by the driver 351 (step S1002), converges the difference on the target value, and thereby, executes the process of determining the driver output duty. In this case, the waveform monitoring unit 106 monitors the optical waveform as the electronic waveform through the light receiving element (PD1) 312 and the I/V converter 1 (321a) of the monitor 105 (step S1003).

The waveform monitoring unit 106 stabilizes the peak level of the optical signal using the peak level stabilizing unit 361 and produces the differential outputs (the non-inverter and the inverter outputs) using the differential output unit 362 (step S1004). The AC coupler 901 extracts the alternate current signal component from each of the outputs of the differential output unit 362.

The fixed bias element 902 applies a fixed bias to the outputs of the AC couplers 1 and 2 (901a and 901b) of the non-inverter and the inverter outputs respectively using the fixed bias elements 1 and 2 (902a and 902b). The fixed bias elements 1 and 2 (902a and 902b) apply bias voltages of the same potential. The smoothing units 903 execute the smoothing by extracting the modulated component of the signal (step S1005). The smoothing units 1 and 2 (903a and 903b) respectively execute the smoothing of the non-inverter and the inverter outputs. The difference detecting unit 364 outputs to the controller 331, the difference of the non-inverter and the inverter outputs, as the smoothed value difference monitor signal.

The controller 331 determines whether the value of the difference of the smoothed value difference monitor signal is equal to the target value set at step S1001 (or is converged within a predetermined range) (step S1006). If the controller 331 determines that the smoothed value difference is not equal to the target value (step S1006: NO), the controller 331 calculates a duty control value by which the smoothed difference value approaches the predetermined value (step S1007) and returns to the process at step S1002. If the controller 331 determines that the smoothed value difference is equal to the target value (or is within the predetermined range) (step S1006: YES), the controller 331 determines that the output duty of the driver 351 at this time is used (step S1008) and causes the process to come to an end.

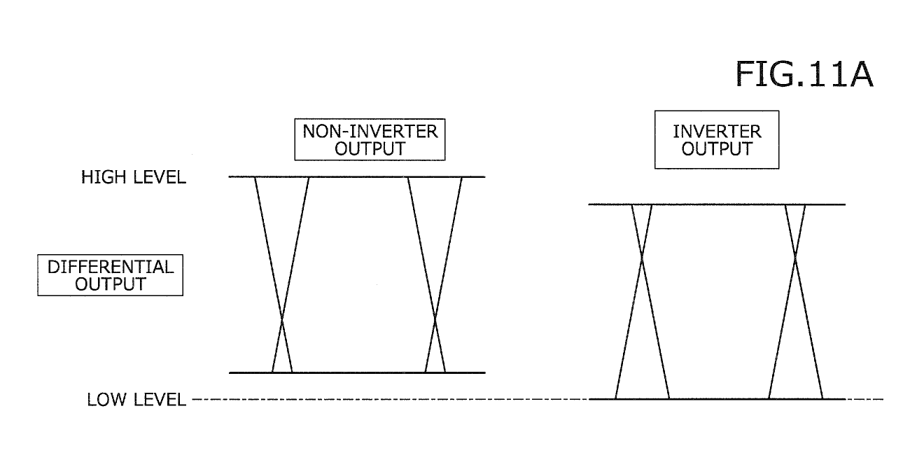

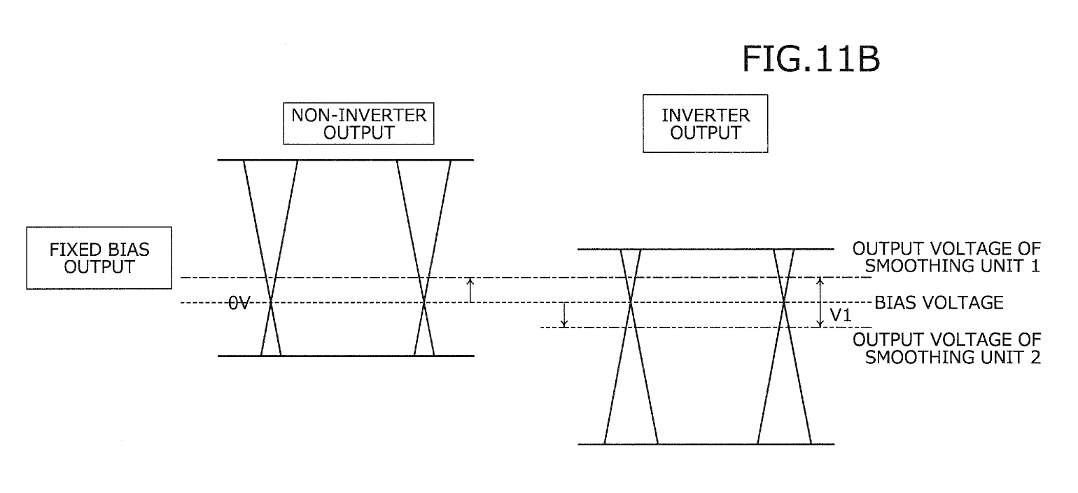

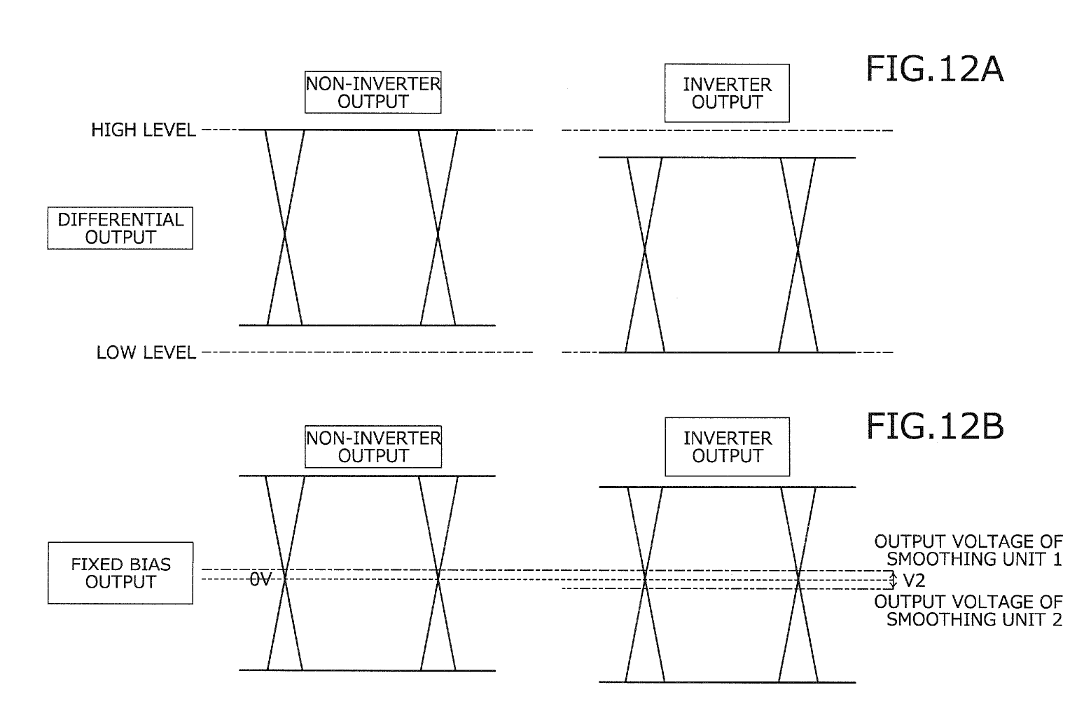

FIGS. 11A, 11B, 12A and 12B are diagrams of examples of output waveforms for different duty ratios, and respectively depict those of the cases where the duty ratio is large and where the duty ratio is small. FIGS. 11A and 12A depict the differential outputs of the differential output unit 362. FIGS. 11B and 12B depict the fixed bias outputs of the fixed bias element 902.

The right portions and the left portions of FIGS. 11A, 11B, 12A and 12B respectively depict the non-inverter and the inverter outputs. In FIGS. 11A, 11B, 12A and 12B, the ratio of the ON time period to the OFF time period of the signal at the central level between the “L” and “H” levels represents the duty ratio. As depicted in FIGS. 11A and 11B, the differential output unit 362 outputs the non-inverter output whose peak level of the optical signal matches with (sticks to) the “H” level, and outputs the inverter output whose bottom level of the optical signal matches with the “L” level.

For the fixed bias element 902, a crossing portion (a cross point) of the optical signal is positioned in the 0-V portion of the AC coupling as depicted due to the AC coupling by the AC coupler 901. The fixed bias element 1 (902a) of the fixed bias element 902 increases the DC level of the overall non-inverter output by applying the fixed bias voltage. The fixed bias element 2 (902b) decreases the DC level of the overall inverter output by applying the fixed bias voltage.

In the case where the duty ratio is large as depicted in FIG. 11B, a potential difference V1 between the smoothing units 1 and 2 (903a and 903b) of the smoothing unit 903 is higher than a potential difference V2 therebetween in the case where the duty ratio is large as depicted in FIG. 12B.

The difference detecting unit 364 detects the difference of the potential difference between the smoothing units 1 and 2 (903a and 903b) and outputs the detected difference to the controller 331 as the smoothed value difference monitor signal.

The controller 331 controls the output duty of the driver 351 such that the difference of the smoothed value difference monitor signal is zero, and thereby, can set the duty ratio of the optical output to be 50% (corresponding to the waveform of FIGS. 12A and 12B). Without limitation hereto, the controller 331 can also set the duty ratio of the optical output to be an arbitrary value (corresponding to the waveform of FIGS. 11A and 11B) by controlling the output duty of the driver 351 such that the difference of the smoothed value difference monitor signal is the predetermined constant value.

With a configuration to control the voltage of the first phase adjuster (the electrode) 305C instead of the configuration to control the output duty of the driver 351, the controller 331 can also vary the duty ratio of the optical output to be the constant value.

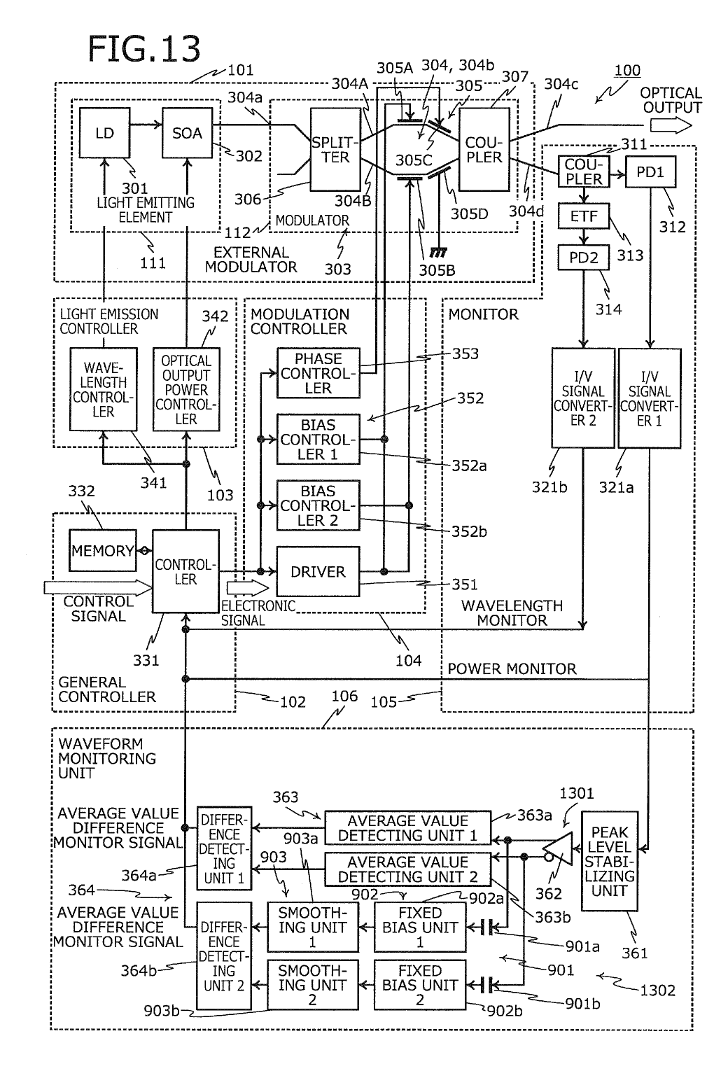

FIG. 13 is a block diagram of an example of an internal configuration of the optical modulation control apparatus according to the third embodiment. The third embodiment is an example of a configuration to stabilize both the extinction and the duty ratios. The configurations to stabilize the extinction ratio and the duty ratio respectively are same as those of the first and the second embodiments (FIGS. 3 and 9).

The waveform monitoring unit 106 of the third embodiment includes a first and a second detecting units 1301 and 1302 respectively to control the extinction ratio and the duty ratio. The first detecting unit 1301 includes the peak level stabilizing unit 361, the differential output unit 362, the average value detecting unit 363, and the difference detecting unit 364 (the difference detecting unit 1 (364a)) that are depicted in FIG. 3. The second detecting unit 1302 includes the AC coupler 901, the fixed bias element 902, the smoothing unit 903, and the difference detecting unit 364 (the difference detecting unit 2 (364b)) that are depicted in FIG. 9.

Output (the non-inverter output and the inverter output) of the differential output unit 362 is output to the average value detecting units 1 and 2 (363a and 363b) and is also output to the AC couplers 1 and 2 (901a and 901b).

As above, the waveform monitoring unit 106 of the third embodiment has a function of monitoring the extinction and the duty ratios. The controller 331 executes control to stabilize the extinction ratio based on the average value difference monitor signal output by the first detecting unit 1301 and also executes control to stabilize the duty ratio based on the smoothed value difference monitor signal output by the second detecting unit 1302.

For the duty ratio, only the modulated component excluding the DC component of the signal waveform (the fixed bias output depicted in FIG. 11B) is detected and controlled, and therefore, the controller 331 can execute control to stabilize the extinction ratio after causing the duty ratio to stabilize.

In the fourth embodiment, an example will be described of a configuration to acquire the desired pre-chirp amount in addition to the control to stabilize the extinction and the duty ratios described in the above embodiments. The pre-chirp amount is desired to be varied corresponding to the optical transmission path property to compensate the waveform degradation, etc., for long-distance transmission of an optical signal in the optical transmission path 204 (FIG. 2).

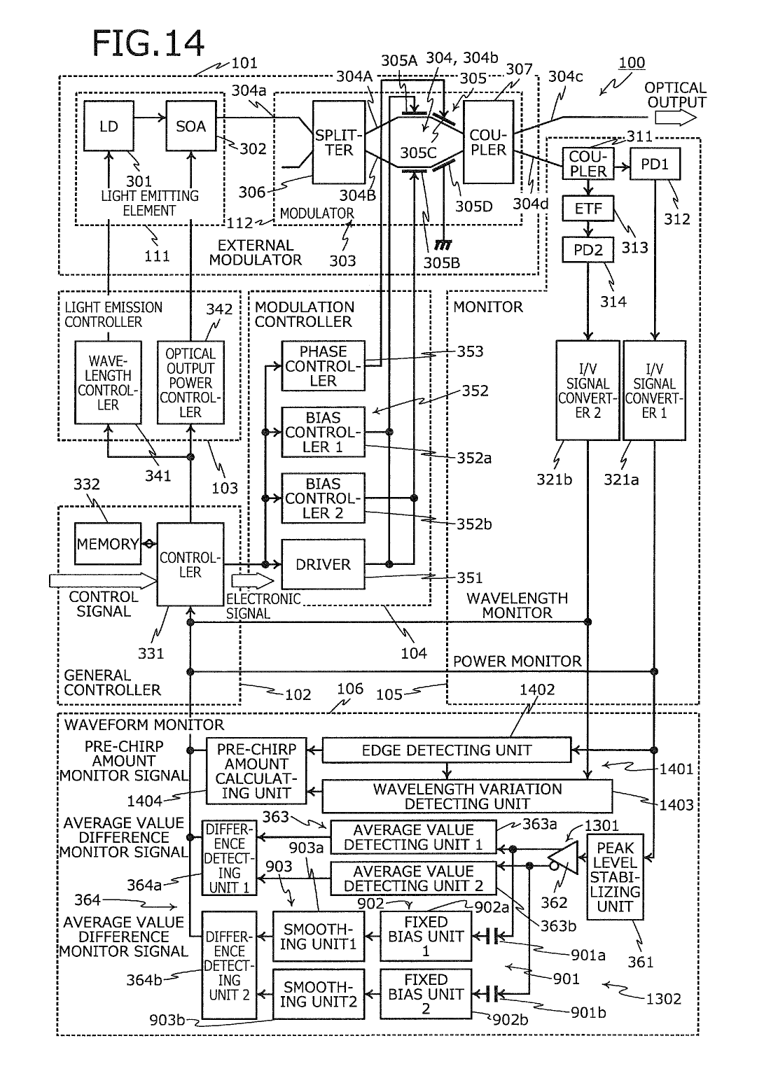

FIG. 14 is a block diagram of an example of an internal configuration of the optical modulation control apparatus according to the fourth embodiment. The waveform monitoring unit 106 of the fourth embodiment includes a pre-chirp amount detecting unit 1401 in addition to the first detecting unit 1301 for the extinction ratio stabilization and the second detecting unit 1302 for the duty ratio stabilization that are described in the third embodiment (FIG. 13).

The pre-chirp amount detecting unit 1401 includes an edge detecting unit 1402, a wavelength variation detecting unit 1403, and a pre-chirp amount calculating unit 1404. The edge detecting unit 1402 detects changes (timing) of the intensity variation (the rising and the falling edges) of the optical output of the I/V converter 1 (321a). The wavelength variation detecting unit 1403 detects the wavelength variation amount at the timing of the optical intensity variation based on the optical output of the I/V converter 2 (321b) and timing information of the optical intensity variation from the edge detecting unit 1402. The pre-chirp amount calculating unit 1404 calculates the pre-chirp amount based on the intensity variation amount of the edge detecting unit 1402 and the wavelength variation amount of the wavelength variation detecting unit 1403, and outputs a pre-chirp amount monitor signal to the controller 331.

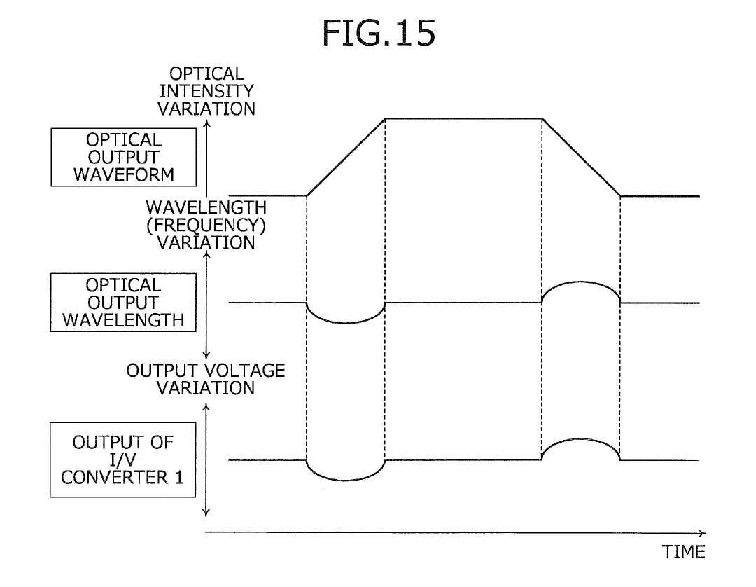

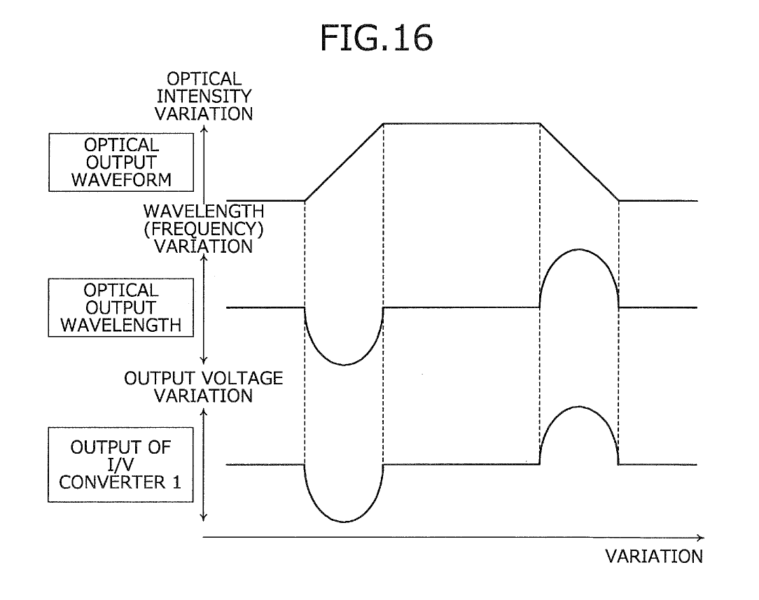

FIGS. 15 and 16 are diagrams of waveforms obtained when the pre-chirp amount is varied. The horizontal represents the time and the vertical axes represent, from an upper portion toward the lower portion, the optical output waveform (the optical intensity) and the optical output wavelength of the modulator 112, and the output (the voltage) of the I/V converter 1 (321a).

FIG. 15 depicts a case where the pre-chirp amount is small and, in this case, the wavelength variation amount is small with respect to the optical output intensity variation. In contrast, as depicted in FIG. 16, when the pre-chirp amount is large, the wavelength variation amount is large with respect the optical output intensity variation. Therefore, the pre-chirp amount calculating unit 1404 can calculate the pre-chirp amount based on the changes over time of the optical intensity variation amount and of the wavelength variation amount.

For example, two methods as below are present as the methods of varying the pre-chirp to obtain the desired arbitrary pre-chirp amount.

### (1) Modulation Amplitude Ratio Variation Method

The modulation amplitudes applied to the two electrodes (the first and the second electrodes 305A and 305B) are asymmetrically set.

### (2) Bias Voltage Variation Method

The bias voltages applied to the two electrodes are asymmetrically set.

In the case of method (1), control is executed to vary the ratios of the modulation amplitudes between the two electrodes (the first and the second electrodes 305A and 305B) while monitoring the pre-chirp amount using the pre-chirp amount detecting unit 1401 such that the desired pre-chirp is acquired. In this case, the amplitude adjustment is executed while matching the modulation ratio based on the result of the detection of the extinction ratio, whereby the pre-chirp amount can be varied while maintaining the extinction ratio. As for the duty ratio, similar to the case of the extinction ratio, the duty ratio adjustment is executed while matching the modulation ratio based on the result of the detection of the duty ratio, whereby the pre-chirp amount can be varied while maintaining the desired duty.

In the case of method (2), control is executed to vary the bias voltage difference between the two electrodes (the first and the second electrodes 305A and 305B) while monitoring the pre-chirp amount using the pre-chirp amount detecting unit 1401 such that the desired pre-chirp is acquired. However, when the bias voltage is set to be deep (high), the desired extinction ratio tends not to be acquired and therefore, preferably, control is executed to detect the bottom level of the extinction ratio and to multiply the bias voltage by a predetermined correction value that corresponds to the detected value.

Even when the pre-chirp amount is varied using either method (1) or (2), the stabilization control is executed for each of the extinction and the duty ratios while the monitoring is continued and therefore, the pre-chirp amount can be varied while maintaining the optical output waveform.

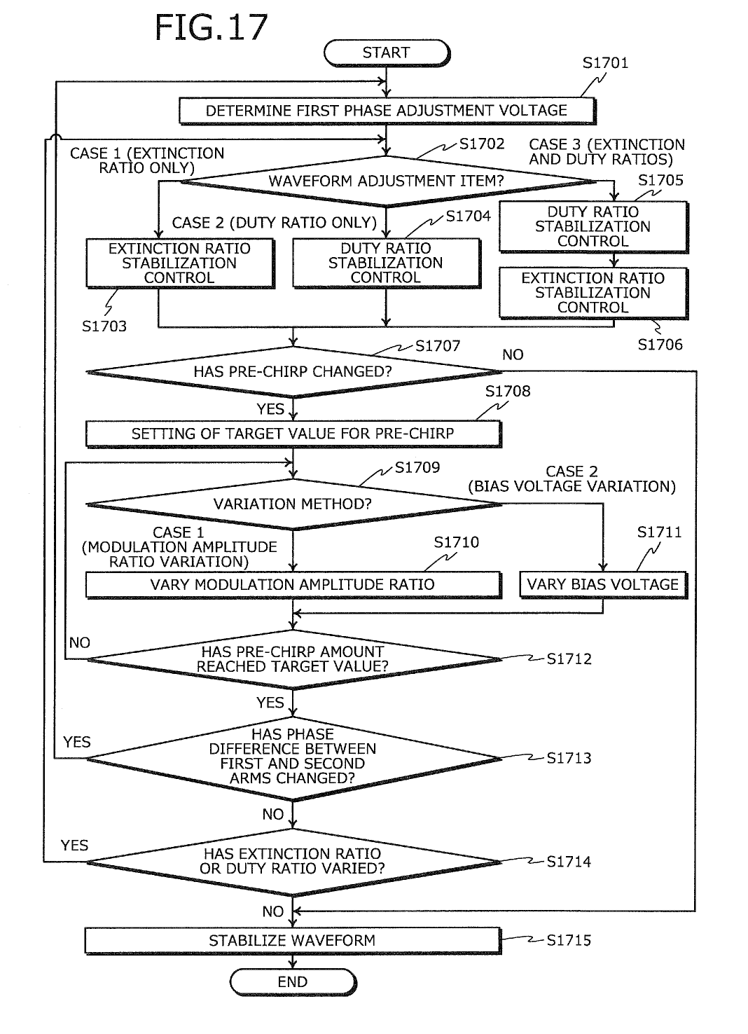

FIG. 17 is a flowchart of control processes to stabilize the extinction and the duty ratios, and to vary the pre-chirp according to the fourth embodiment. The waveform monitoring unit 106 depicted in FIG. 14 includes the first and the second detecting units 1301 and 1302. The controller 331 executes the control of the pre-chirp amount in addition to the control of the extinction ratio stabilization, the control of the duty ratio stabilization, or control of the extinction and duty ratios stabilization. Control processes executed by the controller 331 will be described.

The controller 331 executes the process of determining the first phase adjustment voltage to be applied to the first phase adjuster (the electrode) 305C (the phase difference correction process, see FIG. 4) (step S1701); and determines the waveform adjustment item (the adjustment information) input by the user (the manager), etc. (step S1702).

If the controller 331 determines that the waveform adjustment item is the extinction ratio (step S1702: CASE 1), the controller 331 executes the extinction ratio stabilization control described in the first embodiment (FIG. 6) (step S1703). If the controller 331 determines that the waveform adjustment item is the duty ratio (step S1702: CASE 2), the controller 331 executes the duty ratio stabilization control described in the second embodiment (FIG. 10) (step S1704). If the controller 331 determines that the waveform adjustment items are the extinction and the duty ratios (step S1702: CASE 3), the controller 331 executes the duty ratio stabilization control described in the third embodiment (FIG. 10) (step S1705) and, thereafter, executes the extinction ratio stabilization control (step S1706).

After the selection of the waveform adjustment items and the corresponding stabilization control described at steps S1703 to S1706, the controller 331 determines whether the user (the manager) has changed the pre-chirp (step S1707).

If the controller 331 determines that the user has not changed the pre-chirp (step S1707: NO), the controller 331 progresses to the process at step S1715, without executing the following processes. If the controller 331 determines that the user has changed the pre-chirp (step S1707: YES), the controller 331 accepts the setting of the target value of the pre-chirp (step S1708) and accepts the selection of the pre-chirp variation method (step S1709). If the pre-chirp variation method is the modulation amplitude ratio variation method (step S1709: CASE 1), the controller 331 executes the control of the modulation amplitude ratio variation by the modulation amplitude ratio variation method (1) (step S1710). If the pre-chirp variation method is the bias voltage variation method (step S1709: CASE 2), the controller 331 executes the control of the bias voltage variation by the bias voltage variation method (2) (step S1711).

After executing the control at step S1710 or S1711, the controller 331 determines whether the pre-chirp amount has reached the desired target value (step S1712). If the controller 331 determines that the pre-chirp amount has not reached the desired target value (step S1712: NO), the controller 331 returns to the process at step S1709. If the controller 331 determines that the pre-chirp amount has reached the desired target value (step S1712: YES), the controller 331 progresses to the process at step S1713.

The controller 331 determines at step S1713 whether the phase difference between the first and the second arms 304A and 304B has changed (step S1713). The phase difference of the first and the second arms 304A and 304B changes consequent to a variation of the pre-chirp amount. If the controller 331 determines that no phase difference variation is present (step S1713: NO), the controller 331 progresses to the process at step S1714. If the controller 331 determines that the phase difference has changed (step S1713: YES), the controller 331 returns to the process at step S1701 and again executes the phase difference correction process.

Thereafter, the controller 331 determines whether the extinction ratio or the duty ratio has varied (step S1714). If the controller 331 determines that the extinction ratio or the duty ratio has varied (step S1714: YES), the controller 331 returns to the process at step S1702; selects the waveform adjustment item corresponding to the variation; and executes the corresponding stabilization control (any one of steps S1703 to S1706). If the controller 331 determines that the extinction ratio and the duty ratio have varied (step S1714: NO), the controller 331 determines that the waveform is stabilized after the waveform adjustment of the optical signal (the adjustments of the extinction and the duty ratios) and setting of the desired pre-chirp amount (step S1715); and causes the series of process steps to come to an end.

In the above control example, either the modulation amplitude ratio variation method (1) or the bias voltage variation method (2) is selectively executed. Without limitation hereto, control can also be executed using a combination of the modulation amplitude ratio variation method (1) and the bias voltage variation method (2) to vary the pre-chirp amount.

According to the fourth embodiment, the pre-chirp amount detecting unit 1401 continuously monitors the pre-chirp amount, and the controls of the automatic formation and the stabilization of the waveform of the optical signal are executed being interlocked with each other. Thereby, the desired pre-chirp amount can be acquired while maintaining the optical output waveform of the predetermined extinction and the duty ratios.

The control of the variation of the pre-chirp amount has been described in the fourth embodiment. However, as depicted in FIG. 17, the variation of the pre-chirp amount can be executed being combined with any among the extinction ratio stabilization control (the first embodiment), the duty ratio stabilization control (the second embodiment), and the extinction and the duty ratios stabilization control.

According to the embodiments, the optical output waveform of the modulator is monitored; and, based on the monitoring result, an optical signal having the waveform of the desired extinction and duty ratios can be stably output. In particular, even when the transmission property of the semiconductor Mach-Zehnder external modulator and the light receiving sensitivity property of the light receiving element have dependency on the wavelength, the extinction and the duty ratios can automatically be optimally adjusted. Even for the signal light beam of a different wavelength input into the modulator, the automatic shaping and the stabilization of the waveform of the optical signal can be facilitated independent of the wavelength.

Thereby, the transmitter for transmitting optical signals and having the semiconductor Mach-Zehnder external modulator, and the optical module incorporating therein this transmitter can be downsized, and the optical signal having the desired extinction and duty ratios can be stably output. In WDM communication, the automatic shaping of the waveform and stable optical output of the optical signal are enabled even when the wavelength is switched of the optical signal of the transmitter or the optical module. In this case, information concerning the modulation control of the modulator does not need to be stored in the memory, etc., and therefore, any preparatory setting of the setting value for each wavelength becomes unnecessary and increases in the required memory capacity are prevented. Thus, labor necessary for the waveform shaping can be omitted and a reduction of the cost of the apparatus can be achieved.

The variation control of the pre-chirp amount is executed being interlocked with the controls of the extinction and the duty ratios. Therefore, any variations can be corrected of the extinction and the duty ratios caused by the variation of the pre-chirp amount; and an optical signal can be optically output that has the desired pre-chirp amount, the extinction ratio, and the duty ratio of optimal setting states. Even with the configuration to execute the variation control of the pre-chirp amount, similar to the above, the preparatory setting of the setting value for each wavelength is unnecessary and increases in the required memory capacity can be prevented.

In addition to the configuration using the circuit element, the waveform monitoring unit 106 described in the embodiments can be configured by using a processor. In this case, the waveform monitoring unit 106 monitors the waveform of the optical signal output by the modulator 112 and outputs the monitor signal to the controller 103 of the general controller 102 by causing the processor such as a CPU to execute a program of the functions of the waveform monitoring unit 106 store in the ROM. Another configuration can be employed for the controller 103 (the CPU) of the general controller 102 to execute the program of the functions of the waveform monitoring unit 106.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical modulation control apparatus comprising:
an optical modulator that includes a pair of parallel optical waveguides and electrodes disposed parallel to the optical waveguides;
a waveform monitoring unit that executes a predetermined waveform adjustment with respect to a waveform of an optical signal that is output after modulation by the optical modulator, and produces a monitor signal for modulation control; and
a processor that executes the modulation control of the optical modulator, based on adjustment information concerning a desired waveform and the monitor signal output by the waveform monitoring unit such that the waveform of the optical signal that is output after the modulation by the optical modulator becomes a waveform adapted to the adjustment information.

2. The optical modulation control apparatus according to claim 1, wherein
the waveform monitoring unit includes:
a peak level stabilizing unit that makes a peak level of the optical signal to be a predetermined constant value;
a differential output unit that outputs an output of the peak level stabilizing unit as a non-inverter signal and a inverter signal;
an average value detecting unit that detects an average level of the non-inverter signal and an average level of the inverter signal output by the differential output unit; and
a difference detecting unit that detects a difference of the average level of the non-inverter signal and the average level of the inverter signal detected by the average value detecting unit, and
the processor controls an output amplitude of a driver of the optical modulator such that the difference detected by the difference detecting unit becomes equal to a target value that corresponds to a desired extinction ratio.

3. The optical modulation control apparatus according to claim 2, wherein
the waveform monitoring unit further includes:
an AC coupler that extracts an alternate current signal component of the non-inverter signal and of the inverter signal output by the differential output unit;
a fixed bias element that applies fixed biases at a same potential to the non-inverter signal and the inverter signal output by the AC coupler;
a smoothing unit that smoothes the non-inverter signal and the inverter signal output by the fixed bias element; and
a second difference detecting unit that detects a difference between the non-inverter signal and the inverter signal output by the smoothing unit, and
the processor executes any one among:
first control to vary the output amplitude of the driver of the optical modulator such that the difference detected by the difference detecting unit becomes equal to the target value that corresponds to the desired extinction ratio,
second control to vary an output duty of the driver of the optical modulator such that the difference detected by the second difference detecting unit becomes equal to a target value that corresponds to a desired duty ratio, and
a combination of the first control and the second control.

4. The optical modulation control apparatus according to claim 3, wherein
the waveform monitoring unit further comprises:
an edge detecting unit that detects timings of rising and falling of the optical signal;
a wavelength variation amount detecting unit that detects a wavelength variation amount at the timings detected by the edge detecting unit; and
a pre-chirp amount calculating unit that based on the timings detected by the edge detecting unit and the wavelength variation amount detected by the wavelength variation amount detecting unit, calculates a pre-chirp amount of temporary optical phase variation applied to the optical signal, and
the processor, in addition to the any one among the first control, the second control, and the combination, executes third control to vary the pre-chirp amount for the optical modulator such that the pre-chirp amount calculated by the pre-chirp amount calculating unit becomes equal to a desired pre-chirp amount.

5. The optical modulation control apparatus according to claim 4, wherein
the processor executes phase difference correction control to correct a phase difference between the pair of parallel optical waveguides before executing the first control to the third control.

6. The optical modulation control apparatus according to claim 5, wherein
the processor again executes the phase difference correction control, when a variation of the phase difference between the pair of parallel optical waveguides is detected consequent to execution of the third control.

7. The optical modulation control apparatus according to claim 3, wherein
the processor controls the duty ratio of the optical signal by varying a phase adjustment voltage of the optical modulator based on the difference detected by the second difference detecting unit.

8. The optical modulation control apparatus according to claim 1, wherein
the optical modulator is a semiconductor Mach-Zehnder external modulator.

9. A transmitter comprising:
the optical modulation control apparatus according to claim 1; and
an light emitting element that outputs a light beam to the optical modulator, the light emitting element switching among a plurality of light beams having different wavelengths, wherein
the processor executes the modulation control for the optical modulator each time the light emitting element switches the wavelength, such that a waveform of the optical signal detected by the waveform monitoring unit becomes the desired waveform.

10. An optical output waveform control method of controlling, by an optical modulation control apparatus, an optical output waveform of an optical modulator that includes a pair of parallel optical waveguides and electrodes disposed parallel to the optical waveguides, the optical output waveform control method comprising:
controlling modulation by the optical modulator based on adjustment information concerning a desired waveform and a modulation control monitor signal produced by executing a predetermined waveform adjustment on a waveform of the optical signal output after modulation by the optical modulator, the modulation being controlled such that the waveform of the optical signal output after modulation by the optical modulator becomes a waveform adapted to the adjustment information.

11. The optical modulation control method according to claim 10 and comprising
generating the waveform monitor signal by:
stabilizing a peak level of the optical signal to be a predetermined constant value;
outputting as a non-inverter signal and a inverter signal, an output consequent to the stabilizing of the peak level;
detecting an average level of the non-inverter signal and an average level of the inverter signal; and
detecting a difference of the average level of the non-inverter signal and the average level of the inverter signal, wherein
the controlling of the modulation includes first control to control an output amplitude of a driver of the optical modulator such that the detected difference becomes equal to a target value that corresponds to a desired extinction ratio.

12. The optical modulation control method according to claim 11, wherein
the generating of the waveform monitor signal further includes:
extracting an alternate current signal component of the non-inverter signal and of the inverter signal output by the differential output unit;
a fixed bias element that applying fixed biases at a same potential to the non-inverter signal and the inverter signal resulting after the extracting;
smoothing the non-inverter signal and the inverter signal subjected to the fixed biases; and
detecting a difference between the smoothed non-inverter signal and the smoothed inverter signal, and
the controlling of the modulation includes executing any one among:
the first control,
second control to vary an output duty of the driver of the optical modulator such that the difference detected by the second difference detecting unit becomes equal to a target value that corresponds to a desired duty ratio, and
a combination of the first control and the second control.

13. The optical modulation control method according to claim 12, wherein
the generating of the waveform monitor signal further includes:
detecting timings of rising and falling of the optical signal;
detecting a wavelength variation amount at the detected timings; and
calculating based on the detected timings and the detected wavelength variation amount, a pre-chirp amount of temporary optical phase variation applied to the optical signal, and
the controlling of the modulation, in addition to the any one among the first control, the second control, and the combination, further includes executing third control to vary the pre-chirp amount for the optical modulator such that the calculated pre-chirp amount becomes equal to a desired pre-chirp amount.

14. The optical modulation control method according to claim 13, wherein
the controlling of the modulation includes executing phase difference correction control to correct a phase difference between the pair of parallel optical waveguides before executing the first control to the third control.

15. The optical modulation control apparatus according to claim 14, wherein
the controlling of the modulation includes again executing the phase difference correction control, when a variation of the phase difference between the pair of parallel optical waveguides is detected consequent to execution of the third control.

16. The optical output waveform control method according to claim 10, wherein
the controlling of the modulation is executed for the optical modulator each time a light emitting element switches a wavelength input into the optical modulator, the modulation being controlled such that the waveform of the optical signal detected by a waveform monitor becomes equal to a desired waveform.

17. The optical output waveform control method according to claim 13, wherein
the third control includes varying the pre-chirp amount by any one among an asymmetrical setting of modulation amplitudes applied to the electrodes of the pair of parallel optical waveguides of the optical modulator, and an asymmetrical setting bias voltages applied to the electrodes.
